(19) United States
(12) Patent Application Publication
(10) Pub. No.: US 2021/0148635 A1
(43) Pub. Date: May 20, 2021

(54) WASTE MANAGEMENT SYSTEM

(71) Applicant: Portland State University, Portland, OR (US)

(72) Inventors: Mark M. Weislogel, Portland, OR (US); Rawand M. Rasheed, Portland, OR (US)

(73) Assignee: Portland State University, Portland, OR (US)

(21) Appl. No.: 17/161,212

(22) Filed: Jan. 28, 2021

Related U.S. Application Data
(63) Continuation of application No. PCT/US2019/044527, filed on Jul. 31, 2019.
(60) Provisional application No. 62/716,793, filed on Aug. 9, 2018.

(51) Int. Cl. F26B 3/20

(52) U.S. Cl. CPC F26B 3/20; F26B 2200/04

(57) ABSTRACT

Disclosed herein are embodiments of a waste management device, and methods of using the same. The waste management device disclosed herein comprises a vessel having a wall that has a hydrophobic material at an inner surface thereof, and the wall is maintained at a temperature that is at least at Leidenfrost temperature for a mixture. The waste management device disclosed herein further facilitates separating one or more liquids from the mixture of liquids.

### CROSS REFERENCE TO RELATED APPLICATION

This application continuation of International Application No. PCT/US2019/044527, filed on Jul. 31, 2019, which was published in English under PCT Article 21(2), which in turn claims the benefit of the earlier filing dates of U.S. provisional patent application No. 62/716,793, filed Aug. 9, 2018, both of which are incorporated herein by reference in their entireties.

### FIELD

This invention concerns waste management devices and methods for waste management.

### BACKGROUND

Disposal of waste, such as human waste, that is generated during extended periods of travel (e.g., during space travel) is a serious challenge. For example, if waste cannot be recycled during human space travel, the thrust capability of the spacecraft will need to be sufficient to launch a large volume of water. In addition, other systems employed in a space vessel, or after landing on an extraterrestrial surface, may also require recovery of water to maximize resource efficiency. For example, systems, such as hydroponic farm, bio-reactor, medical lab, or cleaning solution collection tank, that are typically used in spacecraft, may often need to be emptied and it is desirable to separate and reuse water from any of these systems for the benefit of the mission. Separation and recovery of water from human waste and other systems employed in space is critical to the success of space missions.

Additionally, on earth, separation of pure water from sources that are too contaminated for use by humans, animals, and plants remains a resource-intensive process. Water sources polluted with human and animal waste, agricultural runoff, or heavy metals are hazardous to drink, and desalination of salt water requires significant investment in energy, filters, and equipment that creates barriers for adoption of salt water sources into the general water supply

Therefore, there exists a growing need for enhanced waste management and water recycling on earth. Additionally, there is also a growing need for waste management solutions that will enable further extraterrestrial exploration, for example, that allow extended periods of human travel and living in space.

### SUMMARY

Disclosed herein is an embodiment of a waste management device that comprises a vessel having a wall that defines an inlet opening and an outlet opening, the wall having an inner surface that defines a vessel passageway extending between the inlet opening and the outlet opening, at least a portion of the inner surface being a hydrophobic material, the inlet opening being configured to receive a mixture of water and other compounds from a source of the mixture; and a heater operable to maintain at least a portion of the hydrophobic material of the inner surface at a temperature that is at least a Leidenfrost temperature for the mixture.

In some embodiments, the waste management device comprises a nozzle having a body that defines an orifice inlet, an orifice outlet, and an orifice passageway extending between the orifice inlet and the orifice outlet, wherein the nozzle is located in the inlet opening, the orifice inlet is configured to receive the mixture from a source of the mixture, and the orifice outlet is configured to inject droplets of the mixture into the passageway of the vessel.

In some embodiments, the inner surface of the waste management device is configured to propagate droplets through the passageway, wherein the hydrophobic material of the inner surface has a composition, configuration, and temperature sufficient that water is separated from the mixture in a droplet in the vessel passageway without the droplet contacting the hydrophobic material.

In some embodiments, the nozzle of the waste management device is disposed at an angle relative to the inner surface sufficient to direct the droplet in a first direction toward a first location on the inner surface and such that, as the droplet approaches the first location on inner surface, the droplet is redirected in a second direction that is toward a second location on the inner surface, wherein an angle between the first direction and the second direction is from greater than zero degrees to less than 180 degrees.

In some embodiments, the composition of the hydrophobic material and the temperature of hydrophobic material are configured to levitate an injected droplet of the mixture, thereby inhibiting contact between the droplet and the hydrophobic material.

In some embodiments, the waste management device is configured such that the size of an injected droplet of the mixture decreases while propagating through the passageway.

In some embodiments, the waste management device further comprises the vessel outlet that is configured to vent a water-containing fluid from the passageway, and the device further comprises a storage unit configured to collect at least one non-water component of the mixture.

In some embodiments, the waste management device comprises at least a portion of the hydrophobic portion of the inner surface that has a serpentine configuration.

In some embodiments, the vessel of the waste management device comprises a tube in a spiral configuration, wherein an injected droplet of the mixture propagates by rolling and/or sliding along a portion of the inner surface that is proximal to the center of the spiral.

In some embodiments, the waste management device further comprises an insulating layer disposed over the wall, and a protective layer disposed over the insulating layer, wherein each of the insulating layer and the protective layer are configured to inhibit transfer of heat from the inner surface of the wall.

In some embodiments, at least a portion of the wall comprises a porous material, and wherein the device further comprises a jacket that surrounds at least a portion of the wall and that defines a plenum between the jacket and the portion of the wall that comprises the porous material such that pressurized gas in the plenum generates a gas cushion within the passageway alongside the inner surface.

In some embodiments, the hydrophobic material of the inner surface has a Leidenfrost temperature within a range from 30° C. to 230° C.

In some embodiments, the hydrophobic material of the inner surface has a contact angle within a range from about 120 degrees to about 170 degrees.

In some embodiments, the waste management device further comprises a pre-treatment unit fluidly coupled to the inlet opening of the waste management device, a post-treatment unit fluidly coupled to the outlet opening of the waste management device, or a combination thereof.

Disclosed herein is also a method that comprises providing the waste management device; and introducing a mixture comprising water and at least one other compound into the passageway to propagate through the passageway, wherein the hydrophobic material of the inner surface has a composition, configuration, and temperature sufficient that water is separated from the mixture in a droplet in the vessel passageway without the droplet contacting the hydrophobic material.

The foregoing and other objects, features, and advantages of the present disclosure will become more apparent from the following detailed description, which proceeds with reference to the accompanying figures.

### BRIEF DESCRIPTION OF THE DRAWINGS

FIG. 1 is a schematic diagram that depicts a contact angle that is measured when a liquid-vapor interface meets a solid surface.

FIG. 2 is an oblique view of one embodiment of a waste management device.

FIG. 3 is a vertical cross-sectional view of the embodiment of the waste management device of FIG. 2.

FIG. 4 is an oblique schematic view of one embodiment of a passageway, having a cuboid configuration, disposed within the waste management device.

FIG. 5 is a schematic diagram of the passageway of the waste management device.

FIG. 6 is a plan view of the passageway disposed within the waste management device.

FIG. 7 is a cross-sectional elevational view of the passageway, taken along the lines 7-7 in the plan view of FIG. 6.

FIG. 8 is a cross-sectional elevational view of the passageway depicting trajectory of the liquid droplet disposed therein.

FIG. 9 is an overview of one embodiment of the passageway, having a cylindrical configuration, disposed within the waste management device.

FIG. 10 is a schematic diagram of the passageway of the waste management device.

FIG. 11 is a plan view of the passageway disposed within the waste management device.

FIG. 12 is a cross-sectional elevational view of the passageway taken along the lines 12-12 in the plan view of FIG. 11.

FIG. 13 is a cross-sectional elevational view of the passageway depicting trajectory of the liquid droplet disposed therein.

FIG. 14 depicts one embodiment of a method of ejecting one or more droplets within the passageway of the waste management device.

FIG. 15 illustrates one embodiment of the droplet traveling through the passageway of the waste management device.

FIG. 16 is a graphic plot of evaporation lifetime dependence as a function of surface temperature of the droplets traveling through the passageway of the waste management device.

FIG. 17 is a graphic plot of ratchet surface temperature as a function of mean velocity of the droplets traveling through the passageway of the waste management device.

FIG. 18 is a graphic plot of period of ratchets as a function of maximum mean velocity of the droplets traveling through the passageway of the waste management device.

FIG. 19 is a flow chart illustrating an exemplary embodiment comprising a pre-treatment unit and a post-treatment unit fluidly coupled to the waste management unit.

FIG. 20A is an exemplary phase diagram representing variation of Leidenfrost temperature as a function of impact velocity at a pressure of 875 mbar.

FIG. 20B is an exemplary phase diagram representing variation of Leidenfrost temperature as a function of impact velocity at a pressure of 750 mbar.

FIG. 20C is an exemplary phase diagram representing variation of Leidenfrost temperature as a function of impact velocity at a pressure of 500 mbar.

FIG. 20D is an exemplary phase diagram representing variation of Leidenfrost temperature as a function of impact velocity at a pressure of 375 mbar.

FIG. 20E is an exemplary phase diagram representing variation of Leidenfrost temperature as a function of impact velocity at a pressure of 250 mbar.

FIG. 20F is an exemplary phase diagram representing variation of Leidenfrost temperature as a function of impact velocity at a pressure of 128 mbar.

FIG. 21 is a graphic plot of heat flux as a function of Leidenfrost temperature above the boiling point of water.

### DETAILED DESCRIPTION

### I. Overview of Terms

The following explanations of terms are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Although the steps of some of the disclosed methods are described in a particular, sequential order for convenient presentation, it should be understood that this manner of description encompasses rearrangement, unless a particular ordering is required by specific language set forth below. For example, steps described sequentially may in some cases be rearranged or performed concurrently. Additionally, the description sometimes uses terms like “produce” or “provide” to describe the disclosed methods. These terms are high-level abstractions of the actual steps that are performed. The actual steps that correspond to these terms will vary depending on the particular implementation and are readily discernible by one of ordinary skill in the art.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting, unless otherwise indicated. Other features of the disclosure are apparent from the following detailed description and the claims.

Unless otherwise indicated, all numbers expressing quantities of components, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under standard test conditions/methods. When directly and explicitly distinguishing embodiments from discussed prior art, the embodiment numbers are not approximates unless the word “about” is recited. Furthermore, not all alternatives recited herein are equivalents.

Boiling point: is a temperature of a liquid at which the vapor pressure of the liquid equals the pressure surrounding the liquid and the liquid changes into a vapor.

Capillary action: is the ability of a liquid to flow in narrow spaces without the assistance of, or even in opposition to, external forces, such as gravity.

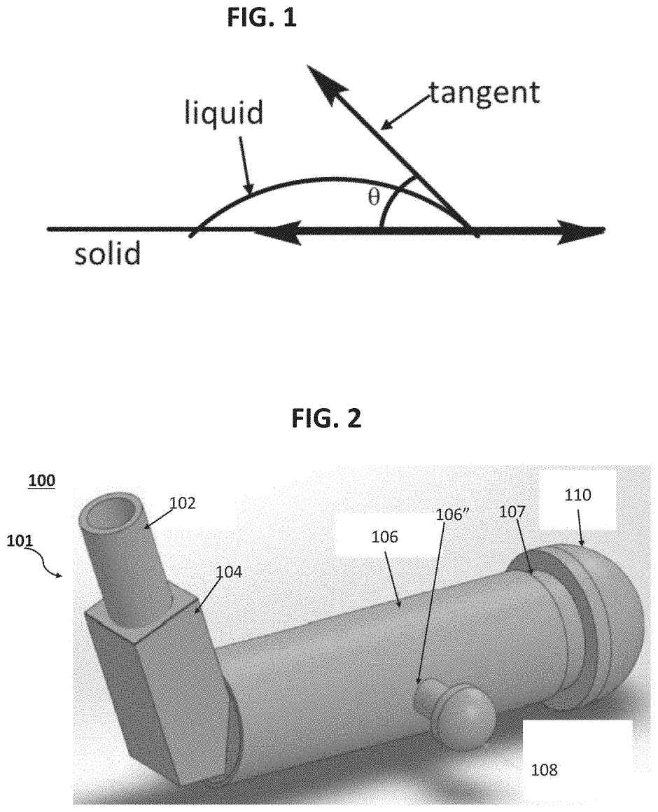

Contact angle: is an angle at which a liquid-vapor interface meets a solid surface, and is represented by the Greek symbol θ. The contact angle is typically measured through the liquid, and is shown in FIG. 1. In some embodiments, the contact angle is determined between adhesive and cohesive forces. In a particular embodiment, the contact angle θ is the angle between a droplet of a liquid and a solid surface.

Hydrophobicity: is the physical property of a molecule (also referred herein as a hydrophobe) that is seemingly repelled from a mass of water.

Leidenfrost phenomenon: a phenomenon in which a liquid, in near contact with a solid significantly above the liquid's boiling point, produces an insulating vapor layer keeping that liquid from boiling rapidly.

Leidenfrost temperature: the temperature of the solid surface above which the liquid undergoes the Leidenfrost phenomenon. In particular disclosed embodiments, Leidenfrost point is the temperature above which the liquid no longer wets the solid surface. In some embodiments, Leidenfrost temperature and Leidenfrost point can be used interchangeably.

Non-contact force: is a force which acts on an object without coming physically in contact with it. Exemplary non-contact force can include, but is not limited to, gravity, electromagnetism, and the like.

Superhydrophobic surface: is a surface that is extremely difficult to wet with water. In particular, a solid surface is super hydrophobic if the water contact angle is greater than 150°.

Surface energy: the excess energy at the surface of a material compared to the bulk of the material, or it is the work required to build an area of a particular surface.

Wetting: is the ability of a liquid to maintain contact with a solid surface, resulting from intermolecular interactions when both the liquid and the solid surface are brought together.

### II. Introduction

Disclosed herein are embodiments of a novel waste management device, for example, for use with separation and recovery of water from waste, such as human waste, and a method of separation and recovery of water from waste. Although significant advances have been achieved in space exploration, disposal and storage of the wastes, such as human waste, generated during human space travel remains a challenge for maintaining sanitary conditions during such travel. Maintenance of the human wastes is not only desirable due to issues related to hygiene and space constraints, but the recovery of purified liquids, such as water from such waste may be useful for the sustenance of the crew without jeopardizing their health and safety. For example, urine comprises approximately 85% water and contaminants, such as urea. Water separated from the other compounds in urine during space travel is a valuable resource. Prior recovery methods have drawbacks, such as bulky and noisy waste management devices, caustic urine pretreatment techniques to prevent microbial growth, use of mechanical parts that are subject to breakdown, such as dynamic seals, valves, and batch control systems, and low recovery goals, in part, due to the addition of pretreatment chemicals. Prior recovery methods that are based on reverse osmosis are energy intensive.

Described herein are embodiments of a reliable, passive, and cost-effective method and device that are capable of separating one or more liquids from a mixture of liquids. In some embodiments, the mixture can be a non-aqueous mixture, such as a mixture of solvents, a mixture of oils, or the like, and the separated liquids can be a corresponding liquid, such as solvent, oil, and the like. In some embodiments, the mixture can be a mixture of organic solvents and non-aqueous solvents, a mixture of organic solvents and aqueous solvents, or any combinations thereof. In some embodiments, the mixture can be a mixture of miscible liquids, a mixture of immiscible liquids, or any combinations thereof. In yet some other embodiments, the mixture can be a homogenous mixture of liquids, heterogeneous mixture of liquids, or any combinations thereof. In some embodiments, the mixture can be mixotrophic solutions. In some embodiments, the mixture can be an aqueous mixture, and the separated liquid can be water that is suitable for reuse. In one example, the aqueous mixture may include, or may be, contaminated water, such as waste water, urine, brine, condensates, and the like. In some embodiments, the liquid (e.g., water) is separated from the mixture by evaporating the liquid at its Leidenfrost point, and subsequently condensing the evaporated liquid. For example, waste management devices of the type disclosed herein can be used to separate water from other compounds and to store the residual waste compounds effectively for extended periods of time.

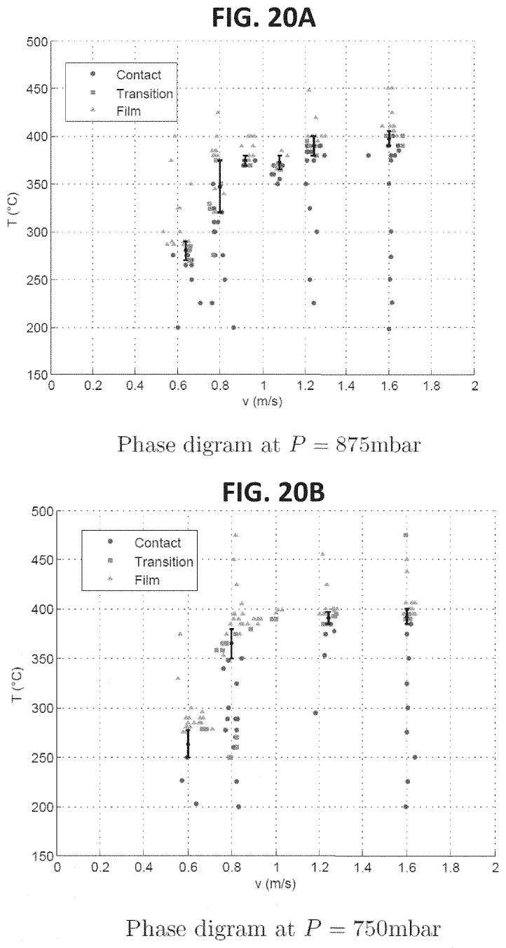

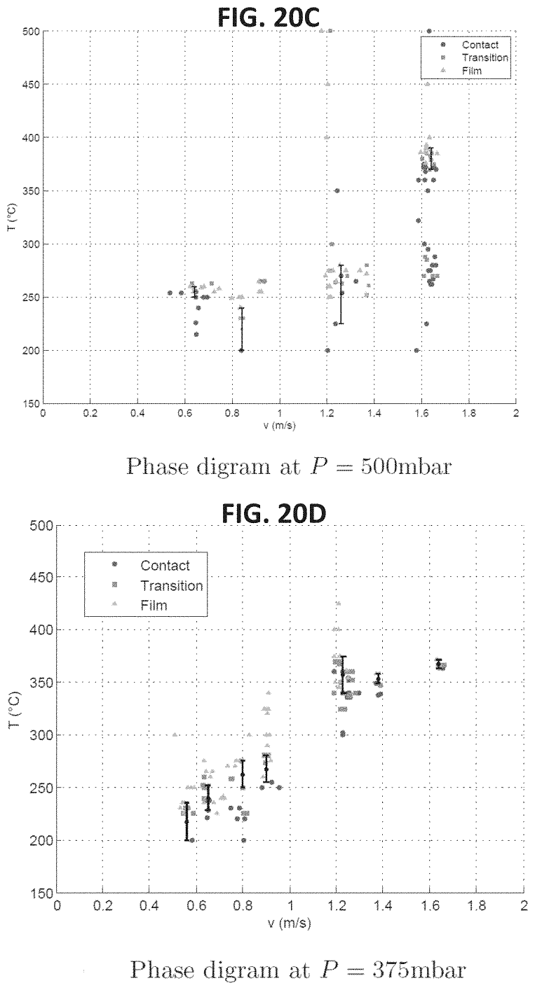

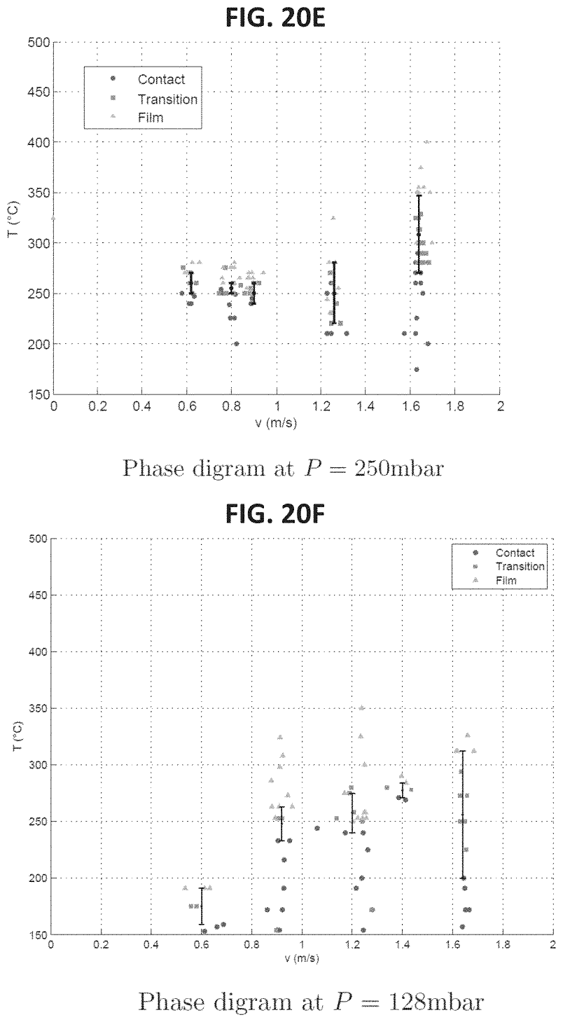

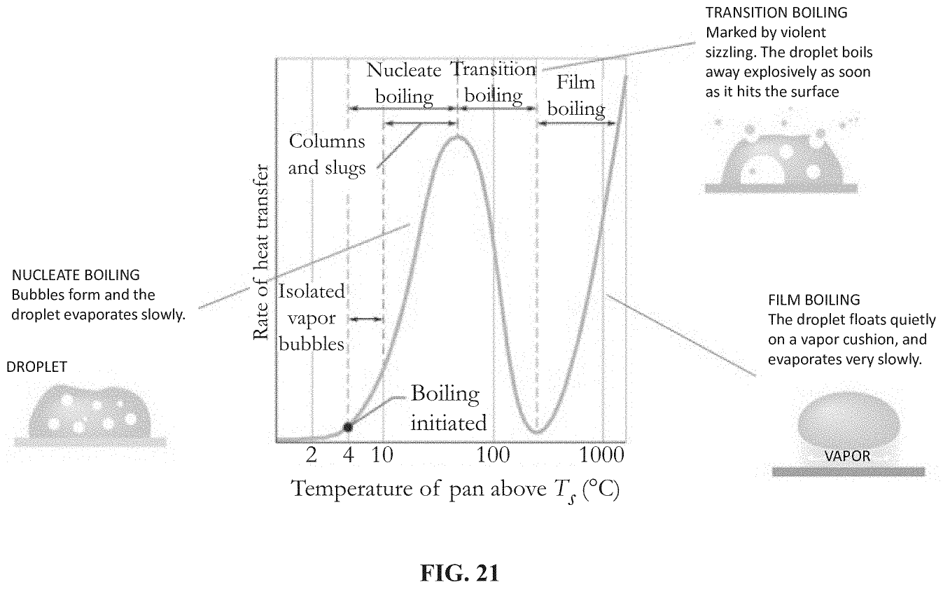

In one embodiment, a waste management device separates water, using a “Leidenfrost phenomenon” which allows a substantially continuous non-contact mechanism to separate the water from the contaminated water. For example, a mixture containing water and other liquid human wastes is ejected through a nozzle in one or more discrete droplets that travel through a passageway of the waste management device. In particular disclosed embodiment, the inner surface of a vessel comprises a hydrophobic material (such as, superhydrophobic material) that is heated at or above a Leidenfrost temperature of water (i.e., at about 150° C.). In some embodiments, the temperature of the superhydrophobic surface is just sufficient to promote evaporation, and to prevent uncontrolled boiling of the liquid disposed therein. As such, in particular disclosed embodiment, the Leidenfrost temperature at which the surface is maintained can be within a range from 30° C. to 230° C., and in particular, at temperature within a range from 40° C. to about 170° C., depending on the pressure at which the device can be operated. FIGS. 20A-20F are exemplary phase diagrams illustrating variations in the Leidenfrost temperature as a function of impact velocity at various pressures. FIG. 21 shows a graphic plot of heat flux as a function of Leidenfrost temperature above the boiling point of water. Additional information concerning the influence of ambient air pressure on the Leidenfrost temperature of liquid droplets can be found in I. C. W. T. A. van Veldhoven et al. (Bachelor Assignment, (2014)) which is incorporated herein by reference in its entirety. The superhydrophobic inner surface allows propagation of the liquid droplets through the passageway by boiling or evaporation and rebounding of the droplets along the length of the passageway. As a person of ordinary skill in the art will understand a liquid drop that initially approaches (e.g., levitates at the surface thereof) a superhydrophobic surface can be characterized into four regimes: single-phase liquid evaporative cooling, nucleate boiling, transition boiling and film boiling. In nucleate boiling, nucleation arises both inside and outside on the surface of the liquid droplet. At a relatively higher temperature, liquid droplets never go through any changes but begin levitating at the surface because of a thin vapor film, namely film boiling behavior. A Leidenfrost temperature is defined as a temperature at which film boiling occurs. More particularly, Leidenfrost temperature is defined as the temperature where the transition from nucleation (i.e., upon contact) to film boiling occurs. Further, a person of ordinary skill in the art will also understand that the boundary between transition boiling and film boiling is the point of lowest heat transfer coefficient, and is denoted as the Leidenfrost point (LFP). The LFP is characterized by levitation of a droplet above a heated surface, supported by the excess pressure of the vapor generated between the droplet and the solid surface. The liquid droplets tend become smaller in size during the propagation due to evaporation, resulting in effectively separating the liquid droplets. The evaporated liquid subsequently condenses and is eventually collected for recycling.

### III. Waste Management Device

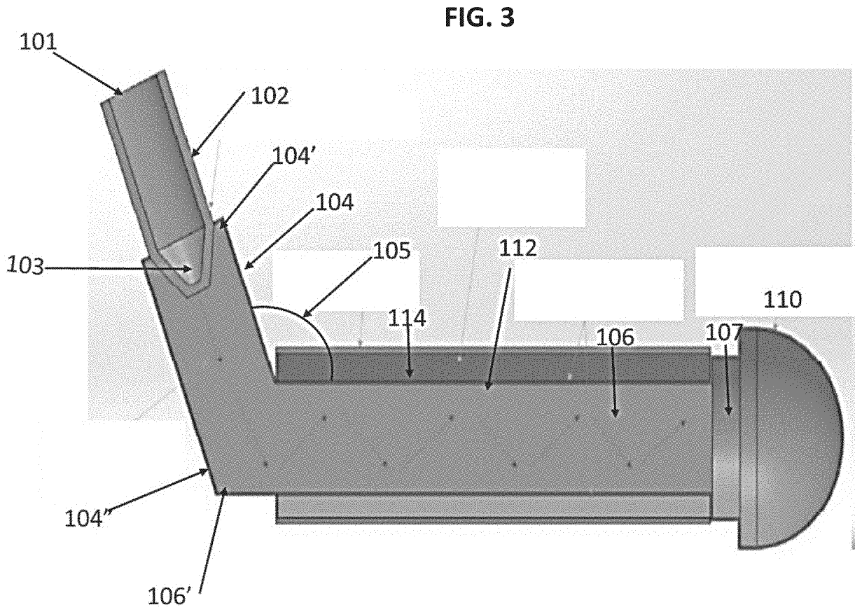

One embodiment of a waste management device 100 comprising a vessel 101 is depicted in FIG. 2. With respect to FIG. 2, vessel 101 includes nozzle 102 having a body that defines orifice inlet 103 (FIG. 3), orifice outlet 105 (FIG. 3), and orifice passageway 102′ (FIG. 3) between orifice inlet 103 (FIG. 3) and orifice outlet 105 (FIG. 3). Orifice outlet 105 (FIG. 3) is inserted into an inlet opening 104′ (FIG. 3) of tube 104. As depicted, tube 104 has inlet opening 104′ (FIG. 3) and outlet opening 104″ (FIG. 3). In an exemplary embodiment, tube 104 may be fluidly coupled to an inlet opening 106′ (FIG. 3) of tube 106, that extends laterally from tube 104. As depicted, tube 106 may also have an outlet opening that is connected to an outlet 108, as described below. In certain disclosed embodiments, tube 106 may be defined as one example of a passageway that is heated at a “Leidenfrost temperature” disclosed herein. In certain embodiments, tube 106 may be directly attached with nozzle 102 in the absence of tube 104 to form a single-piece passageway. In other disclosed embodiments, tube 106 may be disposed at an angle 105 relative to tube 104 so as to ensure unhindered flow of the mixture from nozzle 102 to tube 106. In an exemplary embodiment, tube 106 may be positioned from tube 104 at an angle from about 90° to less than 180°, such as from about 90° to about 160°, and in particular, at an angle from about 90° to about 145°. In one example, tube 104 and tube 106 may have a substantially L-shaped cross-sectional profile, i.e., about 90°. In an exemplary embodiment, nozzle 102 has a passageway 102′ that may have any suitable diameter that is sufficient to accommodate the entire volume of the mixture. In one example, nozzle 102 may have a diameter with a range from about 0.2 cm to about 2 cm, such as 0.5 to 1.5 cm, or 0.75 to 1 cm. Additionally, nozzle 102 can have a length from 100 cm to 20 m, such as 200 cm to 10 m, or 300 cm to 1 m, or 400 cm to 500 cm.

In another embodiment, orifice outlet 105 of the nozzle 102 may have an opening of any suitable diameter that is sufficient to produce droplets at a rate and size suitable for use in the device. In some embodiments, orifice outlet 105 of nozzle 102 may define a hole having a diameter within a range from 0.2 mm to 3 mm, such as 1.5 mm to 2.5 mm, or 1.75 mm to 2 mm. In some embodiments, hole of orifice outlet 105 can produce droplets having a size from 2 mm to 6 mm, such as 3 mm to 5 mm, or 3.5 mm to 4 mm, and at a rate within a range from 2 droplets/second to 7 droplets/second, such as 3 droplets/second to 6.5 droplets/second, or 4 droplets/second to 4 droplets/second. In an exemplary embodiment, orifice outlet opening 105 defines a hole having diameter 2 mm that produces droplets having a size 4 mm, and at a rate of 5 droplet/second. Exemplary embodiment of a material of each of tube 104 and tube 106, respectively, may include, or may be, stainless steel or aluminum. Each of these tubes, i.e., tube 104 and/or tube 106, may be, or may include, a porous material such that, due to the negative pressure in the passageway of the tube, the gas that is jacketed around the device is drawn through the pores to generate a gas cushion within the passageway. As understood, negative pressure refers to a pressure at or below ambient pressure in the one or more passageways of the device. In an exemplary embodiment, operating pressures can range from 0.05 atm to 1 atm. A person of ordinary skill in the art will understand that the gas cushion generated alongside the inner surface of tube 106 is analogous to an air cushion generated over an air hockey table. Advantageously, the gas cushion inhibits a liquid droplet from contacting the inner surfaces of the tube and promotes self-cleaning of the potentially contaminated inner surfaces of the tube. Solely by way of example, the airflow of the device may be maintained at 0.02 CFM (wherein CFM is cubic feet per minute) for a 1 cm inner diameter of tube 106 (with an average velocity of about 10 cm/s). Additionally, or alternatively, vessel 101 may also comprise a jacket (not depicted) that surrounds at least a portion of the walls and that defines a plenum (not depicted) between the jacket and tube 106 (i.e., the portion of the wall that comprises the porous material) such that pressurized gas in the plenum generates a gas cushion within the passageway alongside the inner surface of tube 106.

Further, in some embodiments, the inner surfaces of one or more tubes, (such as, 104, tube 106, and/or any intervening tubes disposed therein) can be coated with a hydrophobic material, superhydrophobic material, omniphobic material, or any combinations thereof, depending on the implementation of the device disclosed herein. In an exemplary embodiment, inner surface of the tubes (e.g., tube 106 and/or tube 104) is coated with a hydrophobic material having a contact angle within a range from 120 degrees to 170 degrees, such as from 130 degrees to 165 degrees. Exemplary embodiment of the hydrophobic material may include, or may be, materials having micro-textured or micro-patterned surfaces; and nano-textured or nano-patterned surfaces, each of these materials may have any suitable surface roughness profile and a surface energy that is less than about 25 mJ/m². Solely by way of example, parameters of the micro-surface roughness profile may be within a range from 1 to 200 micrometers, while parameters of the nano-surface roughness profile may be within a range from 0.5 nanometer to 100 nanometers. Exemplary hydrophobic materials utilized in coating the inner surfaces of tube 106 and/or tube 104 may include, or may be materials, such as polytetrafluoroethylene (PTFE), or silanes, such as, trimethoxypropylsilane, trichloro (1H, 1H, 2H, 2H-perfluorooctyl)silane, trichloro(octadecyl)silane, or the like. In some embodiments, one or more silane materials can be used for micro- and/or nano-roughened materials (which, for example, may be roughened via hydrochloric acid etching). In additional embodiments, the inner surface of tubes (such as, tube 106 and/or tube 104) may be subjected to one or more laser treatments to provide the desired superhydrophobicity. Exemplary laser treatments can include, but are not limited to, pulse laser treatments. In an exemplary embodiment, micro- and/or nano-structured materials (such as, aluminum and/or steel) of tubes (e.g., tubes 104 and 106) can be subjected to a laser etching treatments, and can then be coated with low-energy coatings to induce the desired superhydrophobicity.

In yet other embodiments, the inner surface of tubes (such as, tube 106 and/or tube 104) may include, or may be, an omniphobic surface having a contact angle of about 70 degrees to 160 degrees, such as 90 degrees to 150 degrees, or 120 degrees to 140 degrees. In some embodiments, contact angle of an inner omniphobic surface of tube 106 and/or tube 104 can be from 120 degrees to 160 degrees for water, and from 100 degrees to 130 degrees for oils. In such example, the inner surface of tubes (such as, tube 106 and/or tube 104) may be coated with omniphobic materials that are configured to repel solvents, such as polar solvents, non-polar solvents, or any combinations thereof. Exemplary omniphobic materials can include, but are not limited to, polytetrafluoroethylene (PTFE), polydimethylsiloxane (PDMS), or the like. The omniphobic surface can be used to repel a wide range of fluids including low-surface tension fluids, such as crude oil, Krytox oils, water, etc. Although a tube may have any suitable length that is sufficient for the implementation of the device, solely by way of example, tube 104 may have a length from 5 m to 15 m, and a diameter from 2 mm to 10 mm, while tube 106 may have a length from 5 m to 15 m, and a diameter from 2 mm to 10 mm.

In yet another embodiment, omniphobic surfaces can also be utilized in combination with hydrophobic and/or superhydrophobic surfaces in different portions of the device disclosed herein. In an exemplary embodiment, inner surfaces of tube 106 may be partially coated with superhydrophobic material, and partially with omniphobic material. For example, inner surfaces of tube 106 may be partially coated with superhydrophobic material at a portion proximal to tube 104, while the portion distal to tube 104 may be coated with omniphobic material. Advantageously, a combination of superhydrophobic material and omniphobic material at the inner surfaces of tube 106 can continue to promote non-contact evaporation even when there is a phase transition of the residual wastes that, for example, may be dependent on the concentration of the liquids during the implementation of the device. For example, when water is separated from the contaminated water, such as urine, as the concentration of the water decreases and the concentration of the residual wastes increases in the contaminated water, the residual wastes may tend to be oily. In such an example, the omniphobic surface of tube 106 can continue to promote non-contact evaporation as the oily residual waste component propagates through the device.

Additionally, tube 106 (i.e., of the passageway) is fluidly connected to outlet 108 via an outlet opening 106″. For example, outlet 108 is configured to vent a water-containing fluid from the passageway, and to retrieve liquid vapor that is evaporated during the operation of the waste management device 100. In an exemplary embodiment, outlet 108 may be, or may include, a spherical-shaped container that is hollow inside to allow condensation of the retrieved liquid vapor in the form of purified liquid. Still further, tube 106 (i.e., of the passageway) is connected to storage unit 110 disposed at an opposite end from tube 104, for instance, via storage connector 107. In one embodiment, storage unit 110 is configured to collect the residual wastes during the operation of the waste management device 100, and may be attached directly to tube 106 via storage connector 107. Exemplary sealing components may include, or may be, silicone seals). A person of ordinary skill in the art will understand that each of outlet 108 and storage unit 110 may optionally be connected to tube 106 via one or more sealing components (not shown), and that the positions of each of the outlet and the storage unit relative to tube 106 can be interchangeable, depending on the implementation.

FIG. 3 shows a cross-sectional view of the device of FIG. 2. With respect to FIG. 3, insulating layer 112 is disposed over tube 106 so as to regulate the temperature of tube 106 during the operation of the waste management device. An optional protective layer 114 may also be disposed over insulating layer 112 so as to protect the underlying insulating layer. As described above, tube 106 is heated to a “Leidenfrost temperature” of a liquid to enable the evaporation of the liquid droplet, and the encapsulating insulating layer 112 are configured to inhibit transfer of heat from the inner surface of the vessel, thereby maintaining the “Leidenfrost temperature” of tube 106. In an exemplary embodiment, the tube is heated via electrically, resistively, inductively, or with waste heat from other sources. In some examples, preheat loops may be adopted to enhance thermal efficiency/recovery. Temperature set points may be assured passively via high thermal diffusivity materials, or using thermal fins, heat pipes, heat spreaders, etc. The thermal mass of the device may be maintained at a thermal energy level via trickle, where an excess energy is available to provide complete distillation without dropping below the required Leidenfrost point. Further, tube 106 is connected to outlet 108 (FIG. 2) through an opening (not shown) in insulating layer 112 and overlying protective layer 114. In an exemplary embodiment, insulating layer 112 which may be, or may include, any conventional insulating material, such as, polystyrene foam, multilayer insulation (MLI), fiber insulation, aerogel, or the like, and may have a thickness within a range from 1 cm to 4 cm. Protective layer 114 disposed over insulating layer 112 may include, or may be, a material, such as expanded PTFE, silica-based coating, or the like, and may have a thickness within a range from about 2 microns to 20 microns, such as 5 microns to 15 microns, or 10 microns to 12 microns.

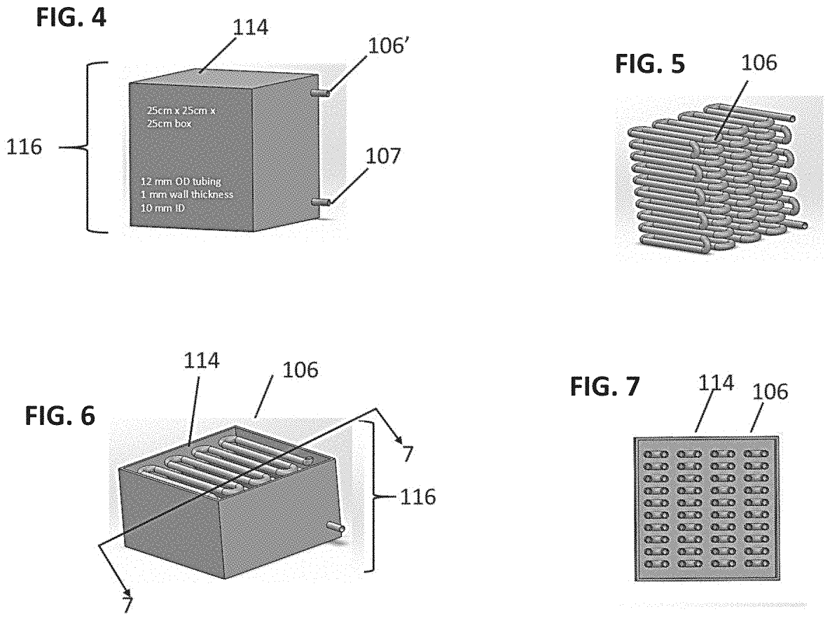

In an additional, or an alternative embodiment, tube 106 may be connected to each of tube 104 (FIG. 3) and storage unit 110 (FIG. 3) via one or more connectors, i.e., tube connector 106′ and storage unit connector 107, respectively, as depicted in FIG. 4. In some embodiments, one or more sealing components (not shown) may be used to connect each of these connectors, 106′ and 107 with tube 106. In such embodiment, depending on the implementation, tube 106 may comprise a single, serpentine tube or a plurality of discrete tubes coupled together to horizontally extend, and zigzagging, to form one continuous tube, as depicted in FIG. 5. Further, as depicted in FIG. 6, tube 106 is encapsulated within insulating layer 112 (See FIG. 3) and protective layer 114 (see FIG. 3), respectively. As depicted, tube 106, insulating layer 112 (see FIG. 3) and protective layer 114 together constitute one example of cuboid passageway configuration 116. In one example, cuboid passageway configuration 116 may have dimensions of about 25 cm×25 cm×25 cm. In another example, while an outer dimension of tube 106 may be within a range from 10 mm to 30 mm, its inner dimension may be within a range from 8 mm to 28 mm, and a thickness within a range from about 1 mm. In a specific example, tube 106 has an outer dimension of about 12 mm, the inner dimension of about 10 mm, and the thickness of about 1 mm.

Further, with reference to FIG. 7, taken along line 7-7 of the structure of FIG. 6, tube 106 of the passageway horizontally extends within protective layer 114 and the underlying insulating layer 112 (FIG. 3), thereby providing adequate length to allow efficient evaporation and rebound of the liquid droplets during the operation of waste management system 100. For example, liquid droplets disclosed herein will propagate through the length (i.e., of the tube 106) of the passageway that has been heated to the Leidenfrost point of water (for example, of about 200° C. at a pressure of 1 atm for a non-hydrophobic surface, or above 120° C. at a pressure of 1 atm for a superhydrophobic surface). As the liquid droplets propagate through the length of tube 106, they tend to become smaller, presumably due to evaporation, and exit as pure gas (for example, such as steam), which can subsequently be retrieved through outlet 108 (FIG. 2), while the residual waste is collected at storage unit 110.

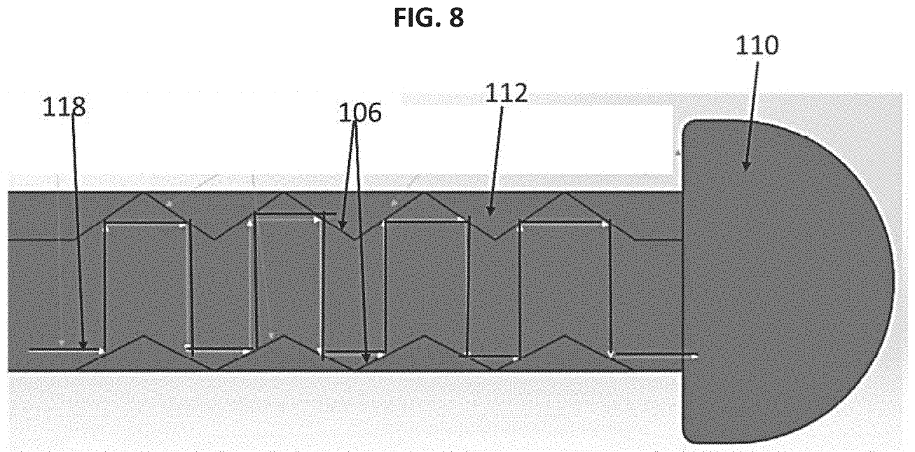

In one exemplary embodiment, the inner surfaces of tube 106 may have an angled configuration (which, for example, may be commonly referred to as “rachets”), owing to either an inherent surface roughness profile of the material of tube 106 or due to the surface roughness profile of the hydrophobic material disposed within the inner surfaces thereof, as depicted in FIG. 8. In such an example, the trajectory 118 of a liquid droplet entering the serpentine tube (i.e., tube 106), upon impact at Leidenfrost temperature of the tube material, will be that each liquid droplet bounces from one angled surface to an opposite angled surface. In particular disclosed embodiment, liquid droplets disclosed herein will propagate through tube 106 (i.e., of the passageway) that has been heated to the Leidenfrost point of water (for example, of about 200° C. at a pressure of 1 atm for a non-hydrophobic surface, or above 120° C. at a pressure of 1 atm for a superhydrophobic surface) by levitating along the inner surfaces of tube 106. The liquid droplets tend to become smaller while propagating through the passageway, presumably due to evaporation of the liquid, thereby forming a liquid vapor. The liquid vapor can subsequently be retrieved through outlet 108 (FIG. 2), and eventually collected as a pure liquid. Further, as described above, the residual human waste is collected at storage unit 110.

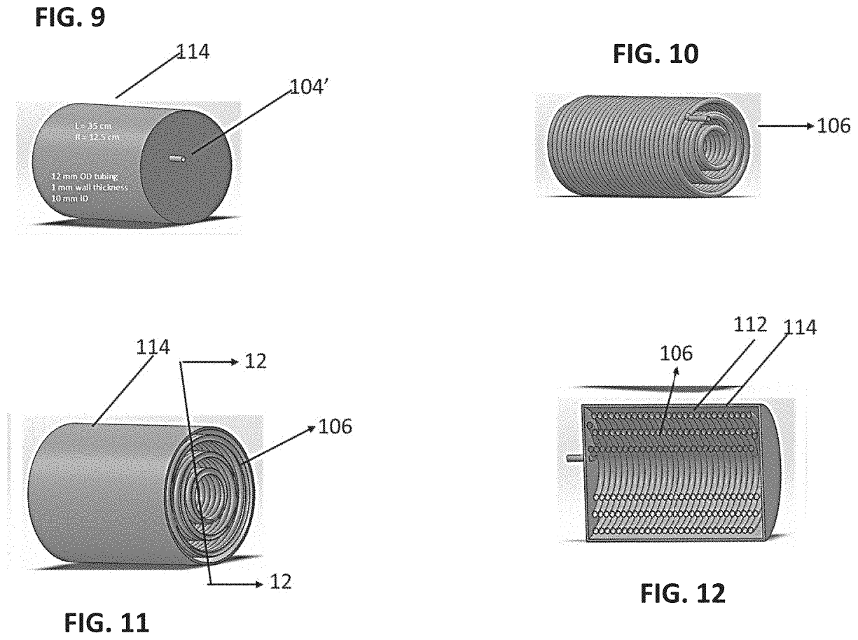

In yet another additional, or an alternative embodiment, tube 106 may be connected to tube 104 (FIG. 2) via a tube connector 104′, as depicted in FIG. 9. Although not depicted in the figures, tube 106 can be attached to storage unit 110 (FIG. 3) at an opposite end via a storage connector (not shown). In such embodiment, tube 106 that is disposed within insulating layer 112 (FIG. 3) and the overlying protective layer 114 (FIG. 3) together constitute one example of a cylindrical passageway configuration. As depicted in FIGS. 10 and 11, tube 106 disposed therein may comprise a single, spiraling configuration. In one example, the cylindrical passageway may have a length within a range from about 20 cm to about 55 cm, while its radius may be within a range from about 10 cm to about 30 cm. Exemplary length of the cylindrical passageway may be about 35 cm, while its radius may be about 12.5 cm. While the outer dimension, the inner dimension and the thickness of the tube 106 may have varying thickness as described above, in one example, the outer dimension may be about 12 mm, the thickness may be about 1 mm, and the inner dimension may be about 10 mm, respectively.

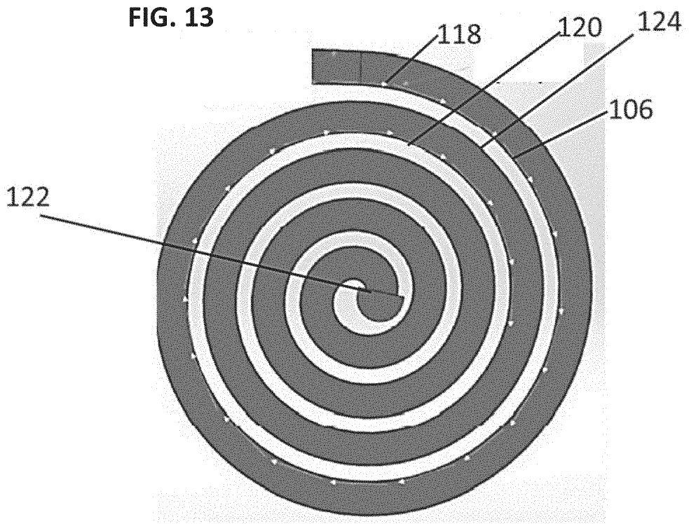

Further, with reference to FIG. 12, taken along line 12-12 of the structure of FIG. 12, tube 106 of the passageway coils within protective layer 114 and the underlying insulating layer 112, thereby providing adequate length to allow efficient evaporation and rebound of the liquid droplets during the operation of the waste management system 100. In certain disclosed embodiments, tube 106 coiling within protective layer 114 and the underlying insulating layer 112 can have two inner surfaces, namely, inner surface 120 that is proximal to center 122 of the coiling tube 106, and inner surface 124 that is distal to center 122 of the coiling tube 106. In some disclosed embodiment, liquid droplets disclosed herein will propagate through the length of the spiraling tube 106 of the passageway, that has been heated to the Leidenfrost point of water (for example, of about 200° C.), by levitating along the inner surface 120 of the coiling tube 106 so as to roll and slide along the superhydrophobic inner surfaces thereof, as depicted in FIG. 13. As the liquid droplets propagate through the length of tube 106, they tend to become smaller and can exit as pure gas (for example, such as steam). The pure gas is subsequently retrieved through outlet 108 (FIG. 2), while the residual human waste is collected at storage unit 110.

As such, waste management device 100 disclosed herein provides a non-contact, cost-effective solution for effective separation of liquids, such as water from liquid human waste, and in particular, low- and zero-gravity conditions. In enhanced embodiment, the device disclosed herein can also be utilized for effectively purifying other liquid streams, including in a cryogenic system. Additionally, the device disclosed herein requires minimal maintenance, and will require a low amount of power (e.g., less than 1500 watts) to operate. Still further, in one example, waste management device 100 disclosed herein is a device that is configured to target a standard urine void for an astronaut (i.e., a crew member), for example, with an optimal volume from 1 L to 100 L, such as 400 mL to 700 mL, for the device. In one implementation, the operating temperatures and pressures utilized may be in the range of 45 to 180° C. and 0.1 to 1 Pₐₜₘ, respectively. As understood, temperature and pressure are typically dictated by water saturation temperature and can be modified to optimize energy loads of the device. In some embodiments, the waste management device disclosed herein is designed to accommodate droplets of liquid waste of about 5 mm in diameter travelling at about 50 cm/s. Still further, although not depicted in the figures, a person of ordinary skill in the art will understand that waste management device 100 disclosed herein may include other components, but are not limited to, resistance heaters to establish system set point temperatures, control electronics, and airflow equipment (ex. Fan/pump, ducting, valving, etc.).

### IV. Methods of Using the Waste Management Device

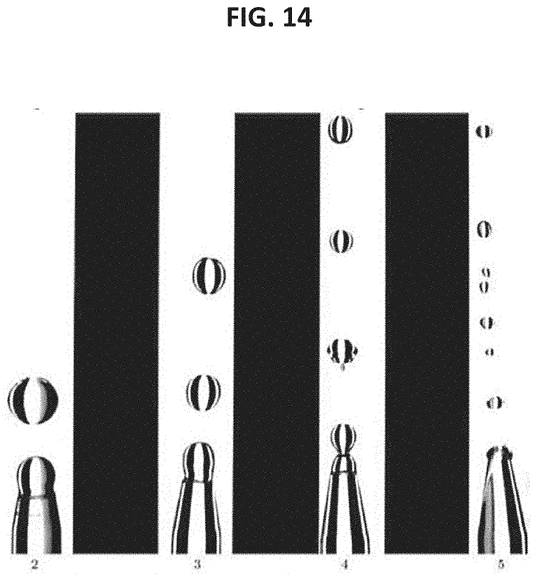

Disclosed herein is an embodiment of a method for using the waste management device described herein. In some embodiments, the mixture, for example, contaminated water (such as, liquid human waste) is introduced into the waste management device disclosed herein through nozzle 102 (FIG. 2). The mixture is ejected through nozzle 102 (FIG. 2) into (i.e., tube 106) (FIG. 2) the passageway, for example, via tube 104 (FIG. 2)) using one or more nozzle droplet ejection techniques, as depicted in FIG. 14. Exemplary nozzle droplet ejection techniques may include, but are not limited to, a single droplet of liquid having a droplet size from 2 mm to 7 mm, or the ejection of multiple discrete droplets having a droplet sizes from 1 mm to 5 mm (e.g., using a liquid droplet radiator).

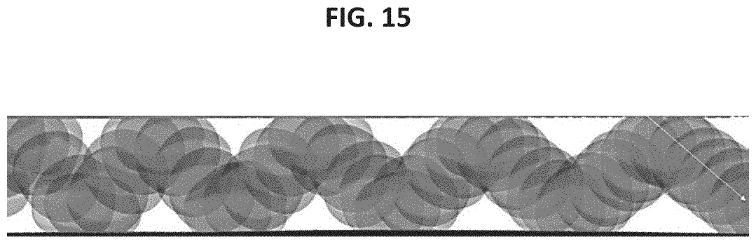

Further, in some embodiments, the liquid droplets propagate in a first direction through tube 106 (FIG. 2) of the passageway that has been coated with a hydrophobic material having a contact angle within a range from about 130° to about 165°. As described above, tube 106 is heated at least to a “Leidenfrost temperature” of a liquid. A person of ordinary skill in the art will understand that the Leidenfrost effect is a phenomenon experienced by a liquid when it comes into close vicinity (i.e., without touching) to a surface that has a temperature that is significantly above the liquid's boiling temperature. In some embodiments, distance between liquid droplet and the surface that has a temperature that is significantly above the liquid's boiling temperature can be any suitable distance for the implementation of Leidenfrost effect. In particular disclosed embodiment, the distance can be within a range from 1 micrometer to greater than 1 cm, such as 10 micrometers to 2 cm, or 100 micrometers to 3 cm, depending on the conditions under which the droplet is interacting with the heated wall surface. As understood, a droplet impact on the heated wall surface can result in a vapor layer that has thicknesses that is in micrometer range, while parallel motion relative to a heated wall surface yields a vapor layer having a thickness that is in centimeter range. As understood by a person of ordinary skill in the art, the phrase “parallel motion” refers to a natural movement of the bulk liquid droplet that has been excited by heat influx. In some embodiments, the drop can tend to move parallel to the surface of the wall thereby providing the heat based on the vaporization and/or sublimation within the droplet. An insulating vapor layer is produced that allows the liquid to rebound off the surface in a second direction relative to the first direction in microgravity. The Leidenfrost effect works to accelerate the liquid droplets (for example, away from the surface of tube 106) in the second direction as they evaporate and become smaller. In an exemplary embodiment, the liquid droplet travels through the passageway of the waste management device disclosed herein as depicted in FIG. 15.

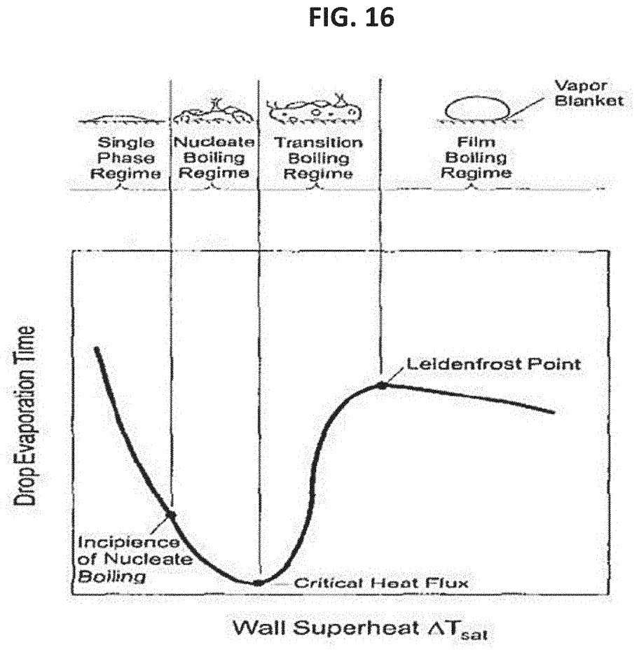

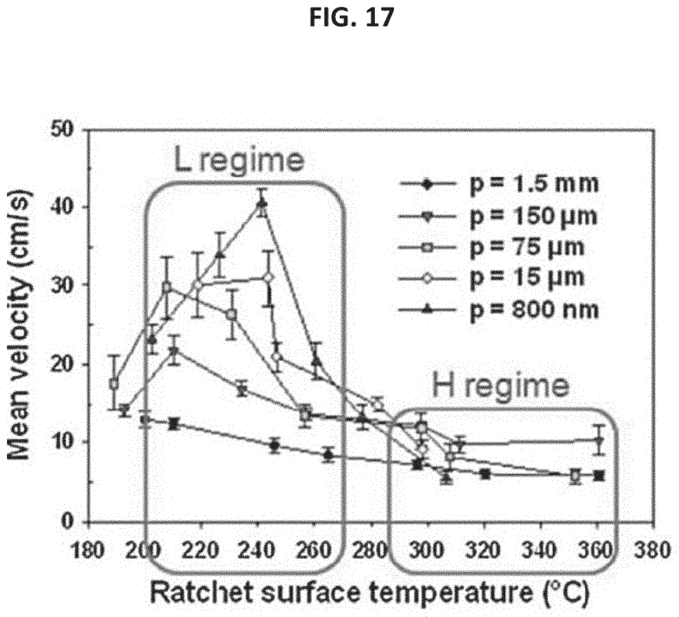

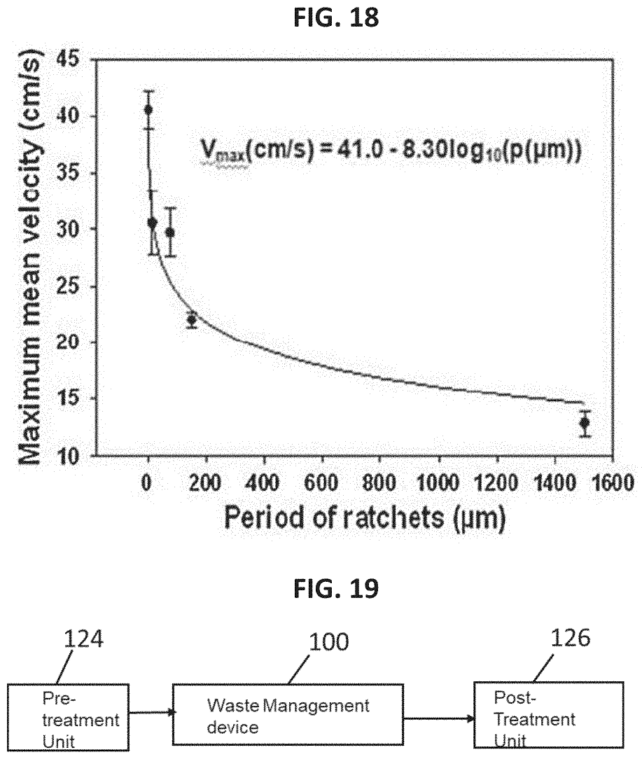

The velocities of the liquid droplet that bounce off the surface of the hydrophobic tube surface will depend on one or more factors, such as, droplet volume, contact angle of the material, wettability pattern, and curvature of the hydrophobic surface. In an exemplary embodiment, FIG. 16 depicts a graphic plot of evaporation lifetime dependence as a function of surface temperature of the droplets traveling through the passageway of the waste management device, while FIG. 17 depicts a graphic plot of ratchet surface temperature as a function of mean velocity of the droplets traveling through the passageway of the waste management device. As depicted in FIGS. 16 and 17, the rate of evaporation of a liquid droplet and droplet mean velocity can be influenced by varying the surface temperatures and the surface materials of tube 106 (FIG. 3) of the passageway. Additionally, as depicted in FIG. 18, ratchet periods of the hydrophobic material surface of tube 106 can also be used to influence the velocity of the droplet propagating through the passageway. As understood by a person of ordinary skill in the art, the term “ratchet” refers to a pattern of textured surface that is designed to create a desired droplet motion, such as velocity, exit angle, and the like. Additional information concerning propulsion of liquid droplets on ratchet surfaces at Leidenfrost temperature can be found in Jeong Tae Ok et al. (Microfluid Nanofluid, 2011, 10:1045-1054) which is incorporated herein by reference in its entirety. Still further, the Leidenfrost temperature can be significantly influenced by the properties of the contacting surface, such as, surface roughness, contamination, and surface materials used, while variations in Leidenfrost temperature of up to 175° C. as a result of changes in surface roughness have been observed. A person of ordinary skill in the art will further understand that the Leidenfrost point of liquids in micro-gravity is reduced relative to that of the earth's gravity, in part, due to the shortened contact time associated with the absence of a body forces. As understood, droplets that impinge an inner heated surface of tube 106 with low normal velocity are propelled away from the heated wall surface before they impact due to the vapor recoil force, in the absence of gravity (e.g., similar to that of the Earth's gravity).

In enhanced embodiment, as described above, the liquid droplet propagating through (i.e., tube 106 (FIG. 2)) of the passageway, that has been heated to Leidenfrost point of the liquid (e.g., water), levitates (i.e., hovers) along the inner surfaces of tube 106 (FIG. 2). The liquid droplet tends to become smaller while propagation, presumably due to the evaporation of the liquid, thereby forming a liquid vapor. The liquid vapor can be subsequently retrieved through outlet 108 (FIG. 1), and eventually collected as a pure liquid, while the residual waste is collected at storage unit 110 (FIG. 1) located at the opposing end of tube 106. Advantageously, the use of superhydrophobic surfaces and the Leidenfrost effect facilitates minimizing contact, such as substantially no contact, of any contact between the liquid droplet and the inner surfaces of the passageway, thus, resulting in a device that remains cleans with minimal maintenance. Further, the use of Leidenfrost conditions allows efficient recovery of the purified liquid (e.g., about 100% recovery of water). Lastly, the liquid droplets will accelerate as they get smaller while propagating through the device resulting in a system that provides enhanced separation of liquids and the resultant waste.

In summary, although various other physical phenomena may be involved, the novel waste management device disclosed herein separates one or more liquids (e.g., water) from a mixture (such as, from contaminated water) by combining the principles of physics including, but not limited to, superhydrophobicity, Leidenfrost phenomena, gas suction, reduced pressure, porous walls, electrostatic fields and the like. In a specific disclosed embodiment, the above key principles of physics ensure that a non-contact force between the capillary motion of the liquid droplets and heated walls of the passageway provide the thermal energy that is required for a distillation process. As such, the five mechanisms of the physical phenomena may be summarized as follows: (1) superhydrophobic walls of the passageway allow dynamic rebounding of the liquid upon impact; (2) Leidenfrost temperatures of the walls of the passageway ensure production of vapor layers around the liquid droplet preventing a droplet-wall contact and adhesion of the droplet; (3) operation of the waste management device at a reduced pressure (i.e., relative to atmospheric pressure) enhances evaporation of the liquid droplet, and wall-vapor recoil force while lowering temperatures for favorable energetics; (4) porous walls (for instance, of the passageway) of the waste management device ensure inward suction of non-condensable portion of the mixture providing cushion of air preventing contact, adhesion, and substrate contamination; and (5) electrostatic field repelling charged droplets from substrate into passageway core, away from heated substrates. Additionally, in some embodiments, the waste management device disclosed herein can be utilized in a variety of implementations that include, but are not limited to, desalination device, hydroponic waste recovery device, waste recovery during space travel, and the like.

Additionally, in some embodiments, the waste management device described herein can be fluidly coupled to a pre-treatment unit via an inlet opening, and/or a post-treatment unit via an outlet opening, such as outlet 108 (see FIG. 2), of the waste management device. In certain embodiments, such as the exemplary embodiment shown in FIG. 19, embodiments of the disclosed waste management device 100 may be fluidly coupled to both a pre-treatment unit 124 via an inlet opening, and a post-treatment unit 126 via an outlet opening. In some embodiments, pre-treatment unit 124 can be, or can comprise, one or more units, such as one or more intake unit(s), one or more filtration unit(s), and the like. In an exemplary embodiment, the intake unit(s) may comprise mechanical screens that can facilitate removing coarse and/or fine particles. In another exemplary embodiment, filtration unit(s) may comprise membranes (e.g., semi-permeable membranes) that can facilitate removing any other impurities, microorganisms, and/or bacteria. Although not depicted in the figures, a person skilled in the art will understand that each of these units may be fluidly coupled with one or more residual units that allow collecting the separated, undesirable contaminants during the operation of such units. Additionally, or alternatively, in some embodiments, post-treatment system 126 can comprise one or more units, such as one or more chemical treatment units, one or more distribution and supply unit(s), and the like. Although not depicted in the figures, in an exemplary embodiment, post-treatment unit(s) 126 may comprise a chemical treatment unit that allows the retrieved liquid vapor to be combined with chemicals (e.g., chlorine and/or fluoride) for further processing.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. A waste management device, comprising:
a vessel having a wall that defines an inlet opening and an outlet opening, the wall having an inner surface that defines a vessel passageway extending between the inlet opening and the outlet opening, at least a portion of the inner surface being a hydrophobic material, the inlet opening being configured to receive a mixture of water and other compounds from a source of the mixture; and
a heater operable to maintain at least a portion of the hydrophobic material of the inner surface at a temperature that is at least a Leidenfrost temperature for the mixture.

2. The waste management device of claim 1, further comprising a nozzle having a body that defines an orifice inlet, an orifice outlet, and an orifice passageway extending between the orifice inlet and the orifice outlet, wherein the nozzle is located in the inlet opening, the orifice inlet is configured to receive the mixture from a source of the mixture, and the orifice outlet is configured to inject droplets of the mixture into the passageway of the vessel.

3. The waste management device of claim 1, wherein the inner surface is configured to propagate droplets through the passageway, wherein the hydrophobic material of the inner surface has a composition, configuration, and temperature sufficient that water is separated from the mixture in a droplet in the vessel passageway without the droplet contacting the hydrophobic material.

4. The waste management device of claim 2, wherein the nozzle is disposed at an angle relative to the inner surface sufficient to direct the droplet in a first direction toward a first location on the inner surface and such that, as the droplet approaches the first location on inner surface, the droplet is redirected in a second direction that is toward a second location on the inner surface, wherein an angle between the first direction and the second direction is from greater than zero degrees to less than 180 degrees.

5. The waste management device of claim 2, wherein the composition of the hydrophobic material and the temperature of hydrophobic material are configured to levitate an injected droplet of the mixture, thereby inhibiting contact between the droplet and the hydrophobic material.

6. The waste management device of claim 2, wherein the waste management device is configured such that the size of an injected droplet of the mixture decreases while propagating through the passageway.

7. The waste management device of claim 1, wherein:
the vessel outlet is configured to vent a water-containing fluid from the passageway, and the device further comprises a storage unit configured to collect at least one non-water component of the mixture;
at least a portion of the hydrophobic portion of the inner surface has a serpentine configuration;
the vessel comprises a tube in a spiral configuration, wherein an injected droplet of the mixture propagates by rolling and sliding along a portion of the inner surface that is proximal to the center of the spiral;
at least a portion of the wall comprises a porous material, and wherein the device further comprises a jacket that surrounds at least a portion of the wall and that defines a plenum between the jacket and the portion of the wall that comprises the porous material such that pressurized gas in the plenum generates a gas cushion within the passageway alongside the inner surface; or
a combination thereof.

8. The waste management device of claim 1, further comprising an insulating layer disposed over the wall, and a protective layer disposed over the insulating layer, wherein each of the insulating layer and the protective layer are configured to inhibit transfer of heat from the inner surface of the wall.

9. The waste management device of claim 1, wherein the hydrophobic material of the inner surface has a Leidenfrost temperature within a range from 30° C. to 230° C.

10. The waste management device of claim 1, wherein the hydrophobic material of the inner surface has a contact angle within a range from 120 degrees to about 170 degrees.

11. The waste management device of claim 1, further comprising a pre-treatment unit fluidly coupled to the inlet opening of the waste management device, a post-treatment unit fluidly coupled to the outlet opening of the waste management device, or a combination thereof.

12. A method, comprising:
providing the waste management device of claim 1; and
introducing a mixture comprising water and at least one other compound into the passageway to propagate through the passageway, wherein the hydrophobic material of the inner surface has a composition, configuration, and temperature sufficient that water is separated from the mixture in a droplet in the vessel passageway without the droplet contacting the hydrophobic material.

13. The method of claim 12, further providing a nozzle having a body that defines an orifice inlet, an orifice outlet, and an orifice passageway extending between the orifice inlet and the orifice outlet, wherein the nozzle is located in the inlet opening, the orifice inlet is configured to receive the mixture from a source of the mixture, and the orifice outlet is configured to inject droplets of the mixture into the passageway of the vessel.

14. The method of claim 12, wherein the providing comprises providing the nozzle at an angle relative to the inner surface sufficient to direct the droplet in a first direction toward a first location on the inner surface and such that, as the droplet approaches the first location on the inner surface, the droplet is redirected in a second direction that is toward a second location on the inner surface, wherein an angle between the first direction and the second direction is from greater than zero degrees to less than 180 degrees.

15. The method of claim 12, wherein the composition of the hydrophobic material and the temperature of the hydrophobic material are configured to levitate an injected droplet of the mixture, thereby inhibiting contact between the droplet and the hydrophobic material.

16. The method of claim 12, further comprising providing a vessel outlet and a storage unit that are fluidly coupled to the passageway, wherein:
the outlet is configured to vent a water-containing fluid from the passageway; and
the storage unit is configured to collect at least one non-water component of the mixture.

17. The method of claim 12, wherein the providing comprises:
providing the vessel comprising at least a portion of the hydrophobic portion of the inner surface having a serpentine configuration;
providing the vessel comprising a tube in a spiral configuration, wherein an injected droplet of the mixture propagates by rolling and sliding along a portion of the inner surface that is proximal to the center of the spiral;
providing at least a portion of the wall comprising a porous material, and wherein the providing further comprises providing a jacket surrounding at least a portion of the wall and that defines a plenum between the jacket and the portion of the wall that comprises the porous material such that pressurized gas in the plenum generates a gas cushion within the passageway alongside the inner surface; or
a combination thereof.

18. The method of claim 12, further comprising providing an insulating layer disposed over the tubing of the passageway, and providing a protective layer disposed over the insulating layer, wherein each of the insulating layer and the protective layer are configured to inhibit transfer of heat from the inner surface of the wall.

19. The method of claim 12, wherein the hydrophobic material of the inner surface has a Leidenfrost temperature within a range from 30° C. to 230° C.

20. The method of claim 12, wherein the hydrophobic material of the inner surface has a contact angle within a range from 120 degrees to about 170 degrees.

21. The method of claim 12, wherein the waste management device further comprises a pre-treatment unit fluidly coupled to the inlet opening, a post-treatment unit fluidly coupled to the outlet opening, or a combination thereof.
